(19) United States
(12) Patent Application Publication
(10) Pub. No.: US 2017/0083211 A1
(43) Pub. Date: Mar. 23, 2017

(54) FOCUSED ATTENTION IN DOCUMENTS AND COMMUNICATIONS

(71) Applicant: MICROSOFT TECHNOLOGY LICENSING, LLC, REDMOND, WA (US)

(72) Inventors: NITHYA RAMKUMAR, REDMOND, WA (US); TOM LAIRD-MCCONNELL, REDMOND, WA (US); SHAN QU, REDMOND, WA (US); SANGYA SINGH, REDMOND, WA (US)

(73) Assignee: MICROSOFT TECHNOLOGY LICENSING, LLC, REDMOND, WA (US)

(21) Appl. No.: 15/078,094

(22) Filed: Mar. 23, 2016

Related U.S. Application Data
(60) Provisional application No. 62/221,606, filed on Sep. 21, 2015.

(51) Int. Cl. G06F 3/0484; G06F 3/0482

(52) U.S. Cl. CPC G06F 3/04842; G06F 3/0482

(57) ABSTRACT

Focused attention elements are provided as a mechanism to explicitly call a user's attention to a specific part of a communication or a document. The fact that a user was mentioned in a conversation or a collaborated document may be used as a signal the conversation or a document section is more relevant to them. If a user whose attention is drawn through a focused attention element is not among the recipient list of the communication or collaborator list for the document, they may be added automatically to the list. Selected portions of a conversation or document to which the attention of one or more users is drawn through the focused attention element may be emphasized, highlighted, or shown differently from a remainder of the conversation or document.

### CROSS-REFERENCE TO RELATED APPLICATION

This Application claims priority under 35 U.S.C. §119(e) to U.S. Provisional Patent Application Ser. No. 62/221,606 filed on Sep. 21, 2015. The disclosure of the U.S. Provisional Patent Application is hereby incorporated by reference in its entirety.

### BACKGROUND

Networked computing and its biggest example, the Internet, allow individual users, businesses, government entities and other organizations to collect, share, and review a wide spectrum of data. One of the commonly and frequently used aspects of networked computing is electronic communication such as emails. Personal and professional electronic conversations are an invaluable part of daily life. Example conversations not only exchange messages among multiple people, but also other forms of data (e.g., attachments), recordings, schedules, tasks, and many more items.

In today's environment, it is hard to stay connected with important and relevant information without feeling overwhelmed. Specifically, within email—the amount of incoming email may be so large, that users may have a hard time picking out relevant and important emails that they should tackle first.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing focused attention in a communication or a collaborated document. In some examples, a focused attention element may be received within a body of a communication or the collaborated document. A control may be presented to enable input or selection of one or more participants in conjunction with the focused attention element. Upon receiving the input or the selection of the one or more participants, the one or more participants may be added to a property and/or a distribution list of the communication or the document.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual display diagram illustrating an example computing environment for providing focused attention in documents and communications, according to embodiments;

FIGS. 2A, 2B, and 2C are display diagrams illustrating example user interfaces of a communication application providing focused attention capability within a communication, according to embodiments;

FIGS. 3A and 3B are display diagrams illustrating example presentation of categorized communications according to focused attention elements;

FIG. 4 is a display diagram illustrating an alternative example user interface of a communication application providing categorization of communications according to focused attention elements;

FIG. 5 is a display diagram illustrating an example user interface of a communication application displaying additional capabilities in conjunction with focused attention elements, according to embodiments;

FIG. 6 is a simplified networked environment, where a system according to embodiments may be implemented;

FIG. 7 is a block diagram of an example computing device, which may be used for providing focused attention in documents and communications, according to embodiments; and

FIG. 8 is a logic flow diagram illustrating a process for providing focused attention in documents and communications, according to embodiments.

### DETAILED DESCRIPTION

As briefly described above, embodiments are directed to focused attention elements as a mechanism to explicitly call a user's attention to a specific part of a communication or a document. Other example embodiments may utilize the fact that a user was mentioned in a conversation as a signal the conversation is more relevant to them. If a user whose attention is drawn through a focused attention element is not among the recipient list of an email, they may be added automatically to the recipient list. Selected portions of a conversation or document to which the attention of one or more users is drawn through the focused attention element may be emphasized, highlighted, or shown differently from a remainder of the conversation or document.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a communication or document processing service with focused attention capabilities. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content o a location. A user experience—a visual display associated with an application or service through which a user interacts with the application or service. A user action refers to an interaction between a user and a user experience of an application or a user experience provided by a service that includes one of touch input, gesture input, voice command, eve tracking, gyroscopic input, pen input, mouse input, and keyboards input. An application programming interface (API) may be a set of routines, protocols, and tools for an application or service that allow the application or service to interact or communicate with one or more other applications and services managed by separate entities.

The technical advantages of providing focused attention in documents and communications may include, among others, increased efficiency in communications, reduced processing and network bandwidth usage (reduced number of communications or documents to be reviewed, exchanged), and improved user interaction by allowing users to receive focused and categorized incoming communications.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with communications.

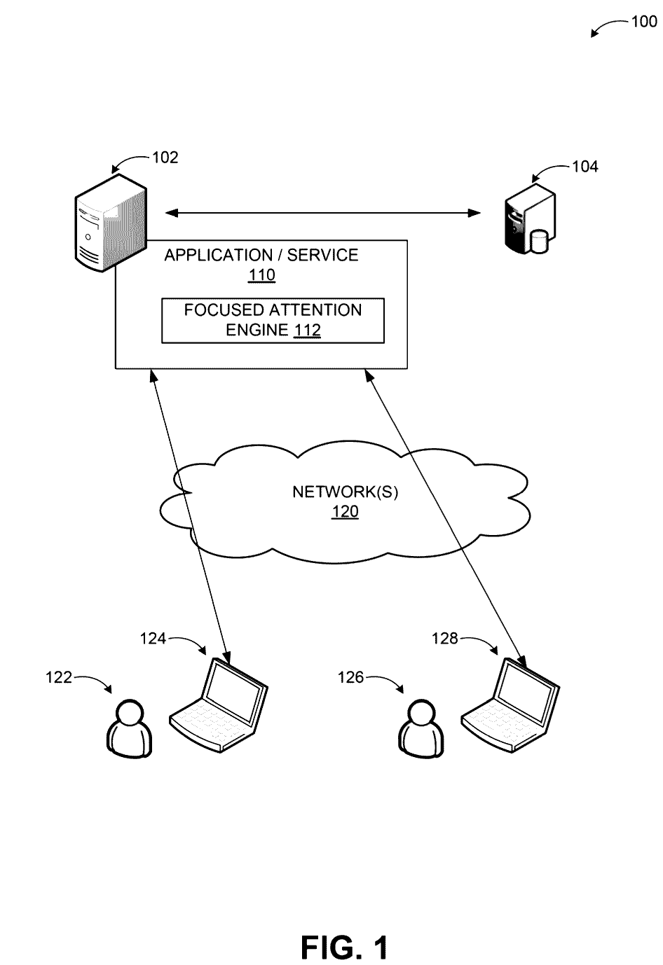

FIG. 1 is a conceptual display diagram illustrating an example computing environment for providing focused attention in documents and communications, according to embodiments.

As shown in a diagram 100, a server 102 may execute an application/service 110 that provides the capability to exchange communication of various modes or processing of documents such as editing, creating, and collaborating. The application/service 110 may also include a focused attention engine 112, which may enable focused attention capabilities in communication and documents to users 122, 126, etc. Exchanged communications or collaborated documents may be stored in one or more data stores (for example, local data stores in users' computing devices, cloud storage, and so on), some of which may be managed by a database server 104. The communications and associated data may be managed by multiple servers. Similarly, the application/service 110 may be executed on multiple servers.

The application/service 110 may provide additional functionality such as calendars, scheduling, note taking, task management, contact management, collaboration, and comparable ones. Various user interfaces may be provided in conjunction with the provided functionality. In some embodiments, the application/service 110 may include distinct applications or modules to provide the different functionalities. In other embodiments, some or all of the modules may be integrated. Furthermore, additional capabilities may be provided through add-ins or integrated third party modules.

Users 122 and 126 may access the application/service 110 through their respective computing devices 124 and 128 over one or more networks 120. The networks 120 may provide wired or wireless communications between nodes, such as the computing devices 124, 128 or the servers 102, 104. In some embodiments, components of the communication service 110 may also be locally executed on a user's computing device. To process the exchanged communications or collaborated documents, the application/service 110 may provide a user experience to the users 122 and 126. The user experience may be a visual display through which the users 122 and 126 may interact with the application/service 110. The interactions may include a touch input, a gesture input, a voice command, eye tracking, a gyroscopic input, a pen input, mouse input, and/or a keyboards input, among others. As discussed in further detail below, the user experience may provide visual indications of focused attention, etc.

The computing devices 124 and 128 may each include a display device, such as a touch enabled display component, and a monitor, among others, to provide access to the application/service 110 for the users 122 and 126 through a web browser (thin client) or a local client application (thick client). The computing devices 122 and 126 may include a desktop computer, a laptop computer, a tablet, a handheld device, a vehicle mount computer, an embedded computer system, a smart phone, and a wearable computer, among other computing devices, for example.

While focused attention to selected subjects are discussed in conjunction with electronic communication conversations herein, embodiments may also be implemented in conjunction with other systems such as documents (word processing, spreadsheet, presentations, etc.). A focused attention element as discussed herein may be any one or more alphanumeric or special characters. Providing focused attention in documents and communications may assist users to achieve the following goals staying focused without distractions when interacting with their communications, collaborating on documents, and quickly catching up on the important items.

While the example system in FIG. 1 has been described with specific components including the server 102, the database server 104, application/service 110, the focused attention engine 112, embodiments are not limited to these components or system configurations and can be implemented with other system configuration employing fewer or additional components.

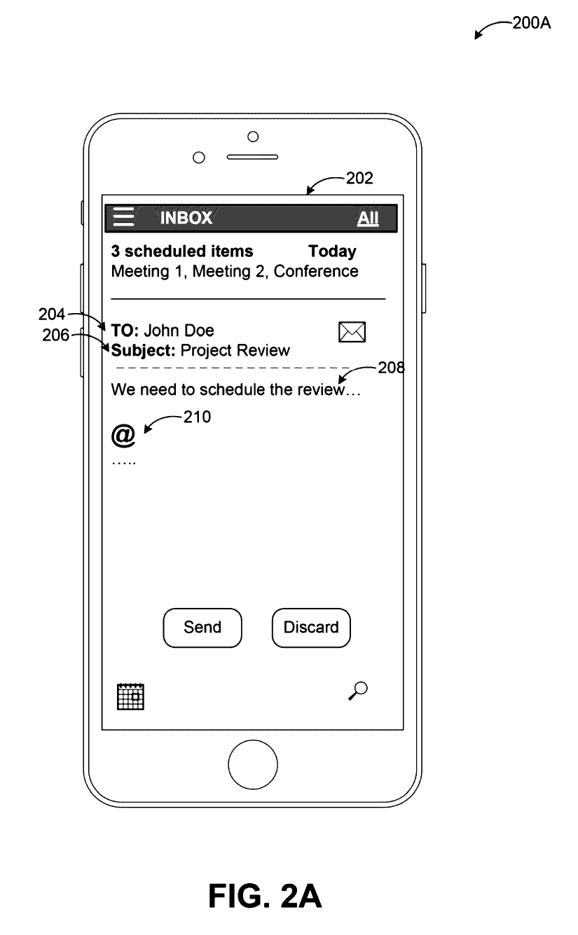

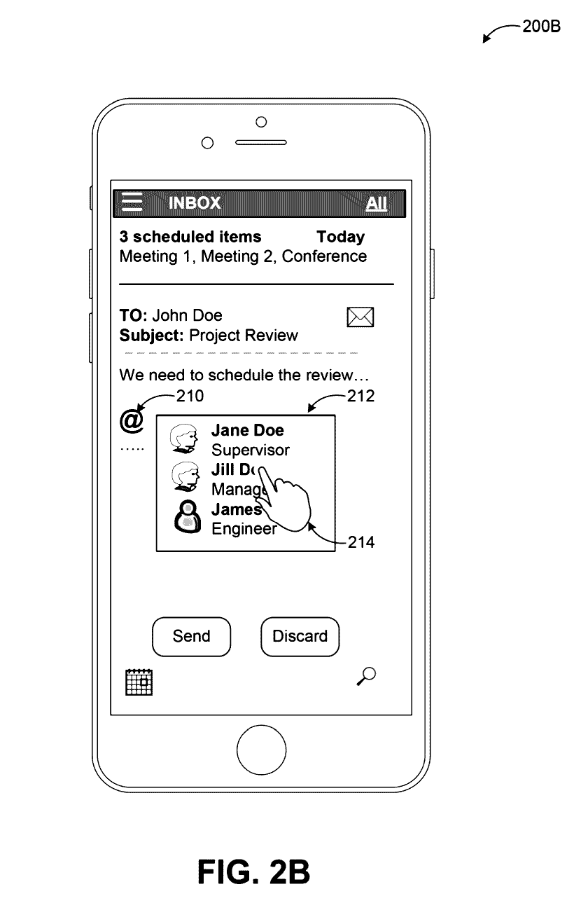

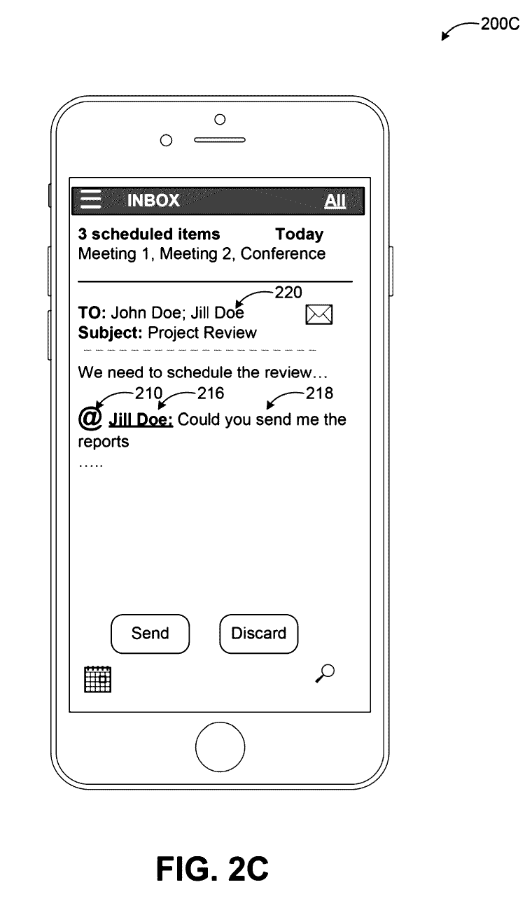

FIGS. 2A, 2B, and 2C are display diagrams illustrating example user interfaces of a communication application providing focused attention capability within a communication, according to embodiments.

Diagram 200A shows a mobile device displaying a user interface of a communication service such as Outlook® by MICROSOFT CORP. of Redmond, Wash. The inbox 202 for a particular user includes a summary information for the day's activities and an email 206 being prepared, for example. The email may include a TO line 204 for direct recipients and a subject line 206 to summarize the content of the email. The email may also include a body 208 with textual and/or other content.

At a location within the body 208 of the email, the sender may input (e.g., type using a physical or virtual keyboard, paste, or use other input mechanism) a focused attention element 210. The focused attention element 210 may be an alphanumeric character, a special character, a graphical element, or similar elements. Moreover, the focused attention element may include more than one character (e.g., “@#” or “&&&”), For example, the “@” character may be used as the focused attention element. The focused attention engine of the email application or underlying communication service may detect the intention to start a focused attention section upon detecting the “@” character in as new line or following a space.

Diagram 200B of FIG. 2B shows the same user interface as in diagram 200A with a people picker menu 212 being displayed upon detection of the focused attention element 210. In some embodiments, the sender may be allowed to type the name of the person whose attention they want to draw. In other embodiments, auto-complete functionality may allow easier typing of the name of the person. In further embodiments, a people picker menu may be displayed providing the sender with a select number of choices among available people. The list on the people picker menu 212 may be based on the sender's contacts, people the sender has interacted with (e.g., sent email to, received emails from, etc.), people associated with a particular project (when the email is associated with a project), people within the organization of the sender, and comparable sources.

Furthermore, the people on the list may be selected and/or ordered based on one or more letters of the name typed by the sender, a context of the email, or an inference made from the sender's history of interactions with people and/or the subject of the email. In a touch-based user interface such as in a mobile environment, the sender may be allowed to select (214) a name from the list displayed by the people picker 212.

Diagram 200C of FIG. 2C shows the same email user interface as in diagrams 200A and 200B with the focused attention section completed. The focused attention section may include the focused attention element 210, the name of the person 216 (typed or selected from the people picker as discussed above), and the content 218 directed to the person 216. The content may be textual, but may also include other content types such as graphics, images, video, audio, links, attachments etc.

Upon typing of the name of the person 216 or selection from the people picker, contact information such as an email address (or text messaging address) may be retrieved for that person. Following the retrieval of the email address or as similar identifier for the person indicated or selected by the sender, the focused attention element 210 may be visually indicated (e.g., through a highlighting, coloring, shading, textual, graphic, etc. scheme). The selected or indicated person may also be added to a distribution list 220 of the email if not already there so that they can be notified. The focused attention element 210 may be followed by more than one person. The sender may be allowed to enter/select as many people as they wish. The email addresses or identifiers of the selected/indicated people may be added to a property of the email so that the email can be filtered based on focus characteristics by a client application or the email service.

While focused attention is described in an example environment of an email in FIG. 2A through 2C, embodiments are not limited to emails. Similar focused attention elements and associated functionality may be employed in scheduling items (e.g., calendar invites), text messages, shared notes or tasks, online conferences, etc. Moreover, similar focused attention functionality and associated user interfaces may be employed in collaborated documents. For example, collaborators may provide comments or communicate otherwise over collaborated documents such as word processing documents, presentations, spreadsheets, graphics documents, and comparable ones.

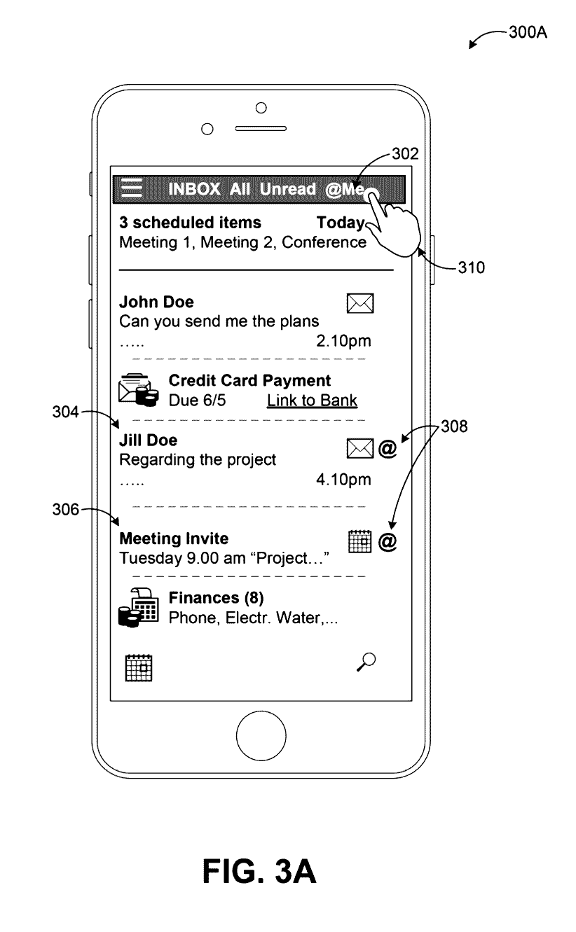

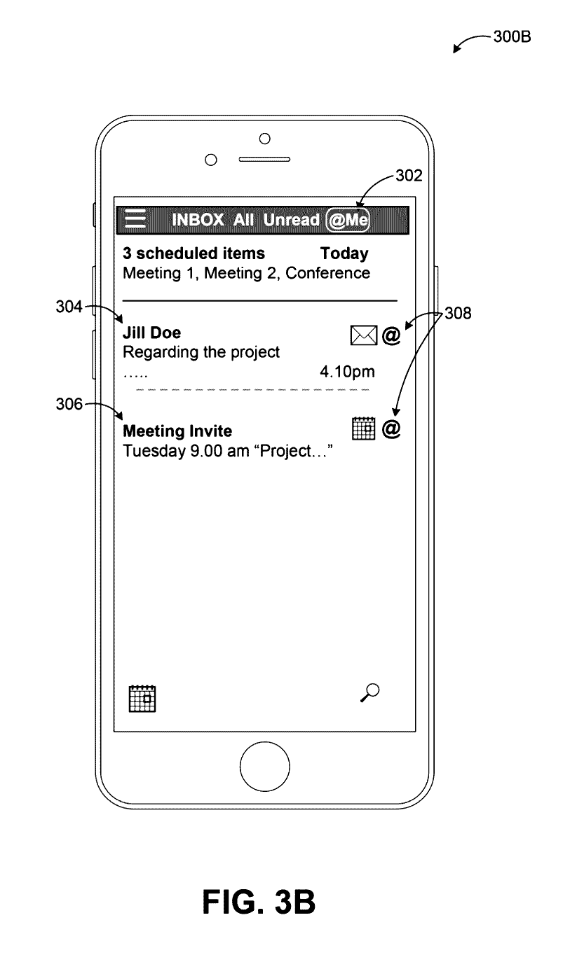

FIGS. 3A and 3B are display diagrams illustrating example presentation of categorized communications according to focused attention elements.

Items that include focused attention elements such as emails as discussed above may be indexed by the underlying application or service (e.g., at an email server) based on the focused attention property such that users can filter and view the items (e.g., emails) based on the focused attention property. Diagram 300A shows the user interface of an email application (in mobile environment) with a focused attention control 302. The inbox may include a number of communication items such as emails, calendar invites, and others. Some of those items such as email 304 and meeting invite 306 may include focused attention elements 308 directed to the user whose inbox is displayed. Upon activation 310 of the focused attention control 302, displayed items may be filtered such that items with focused attention elements are displayed on the user interface as shown in diagram 300B of FIG. 3B. In some embodiments, the user may be the recipient of the items such as emails and the focused attention control 302 may filter the items based on focused attention elements mentioning the recipient's name. In other embodiments, the user may be provided with a choice to filter items based on focused attention elements mentioning other names. For example, a manager of a project may be able to filter items with focused attention elements mentioning names of the project participants individually or in groups.

In further embodiments, the focused attention portions may be displayed in a preview of the email instead of a top portion to provide context, for example. The focused attention portions may also be highlighted or otherwise emphasized within the body of the email (e.g., brought to the top of the body, displayed in a different color, etc.). According to some embodiments, a height of the displayed items, background color of the displayed items, font styles/weights, font colors, icons associated with the displayed items, and labels may be used to indicate focused attention included in such items.

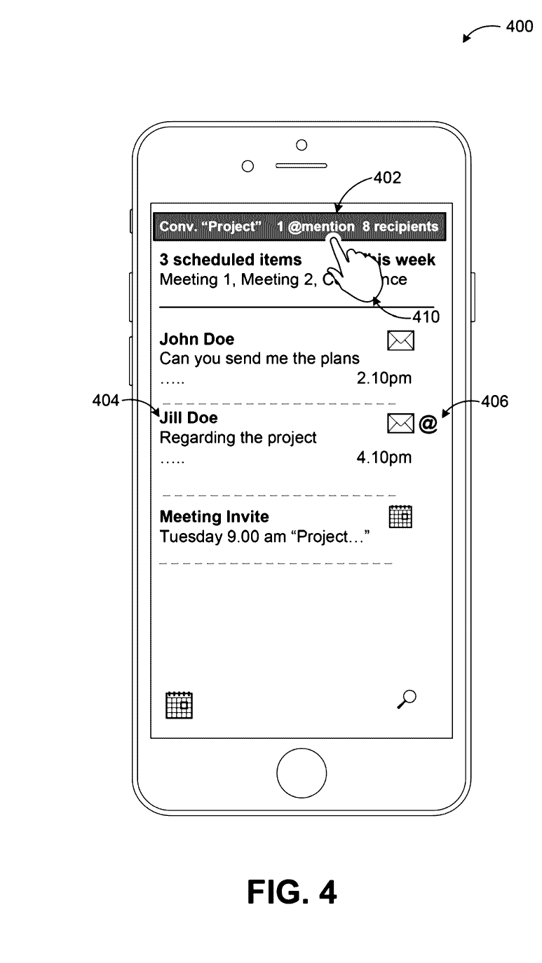

FIG. 4 is a display diagram illustrating an alternative example user interface of a communication application providing categorization of communications according to focused attention elements.

Diagram 400 shows an alternative filtering approach. The email application user interface in diagram 400 includes a top bar 402 indicating that the items listed on the user interface are part of a specific conversation (e.g., “Project”). The top bar 402 further indicates that the items in the conversation include one focused attention element and that there are eight recipients associated with the focused attention element. The focused attention indicator may be a control and upon activation 410, the item 404 with the focused attention element 406 may be brought to the top, filtered from the remaining item, or otherwise emphasized.

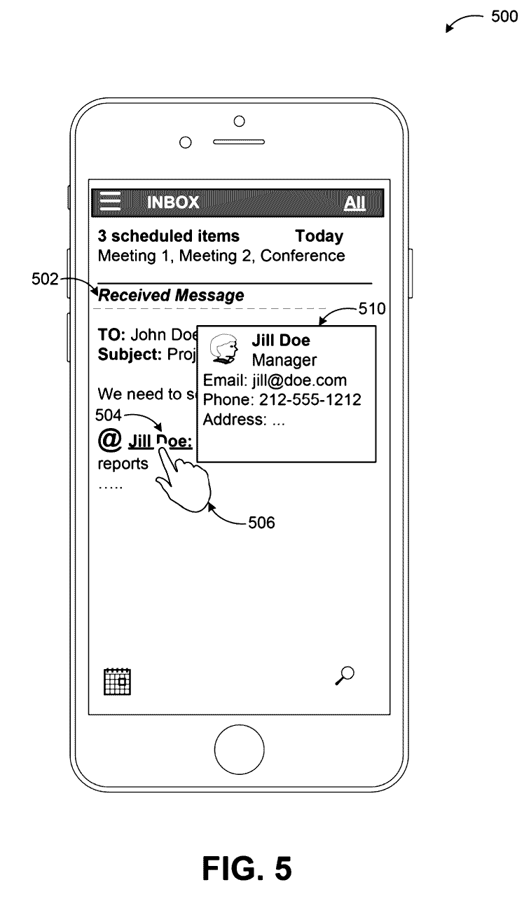

FIG. 5 is a display diagram illustrating an example user interface of a communication application displaying additional capabilities in conjunction with focused attention elements, according to embodiments.

Diagram 500 shows additional example functionality that may be provided in conjunction with focused attention elements to enhance user experience. The example user interface in diagram 500 includes a received message 502 with a focused attention element 504 and associated person's name. Upon selection 506 of the person's name (e.g., clicking on, hovering over, etc.), summary information associated with the person such as a contact card 510 may be displayed. In other examples, messages or other items associated with the person may also be displayed. Furthermore, the user may be provided with options to communicate with the person or other interactive functionality.

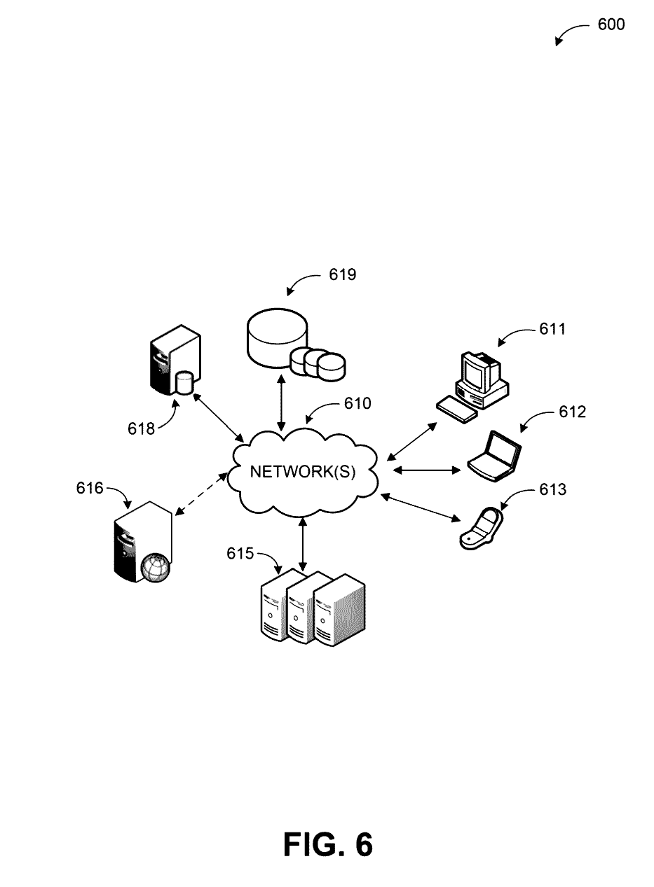

FIG. 6 is a simplified networked environment, where a system according to embodiments may be implemented.

As shown in a diagram 600, an application or a service providing focused attention in documents and communications may be implemented in a networked environment over one or more networks, such as a network 610. Participants may access the application or service through locally installed or thin (e.g., browser) client applications executed on a variety of computing devices 611-613, such as a smart phone 613, a mobile computer 612, or a desktop computer 611 (‘client devices’). The application (or service) may interact with users through locally installed or thin (e.g., browser) client applications executed on a variety of computing devices. Focused attention elements may be used as a mechanism to explicitly call a user's attention to a specific part of a communication or a document. A user being indicated with a focused attention element in a conversation may be used as a signal the conversation is more relevant to them. If a user whose attention is drawn through a focused attention element is not among the recipient list of an email, they may be added automatically to the recipient list. Selected portions of a conversation or document to which the attention of one or more users is drawn through the focused attention element may be emphasized, highlighted, or shown differently from a remainder of the conversation or document.

An application or service, as discussed herein, may be implemented via software executed over servers 615. The servers 615 may include one or more web servers 616, where at least one of the one or more web servers 616 may be configured to provide access to the application or service through web communications. In other examples, the application or service may be provided by a third party service or may include a web application. The application or service may store data associated with exchanged communications or collaborated documents in a data store 619 directly or through a database server 618.

A computing device may communicate with the server over a network 610. The network 610 may comprise any topology of servers, clients, Internet service providers, and communication media. A system according to embodiments may have a static or dynamic topology. The network 610 may include multiple secure networks, such as an enterprise network, an unsecure network, or the Internet. The unsecure network may include a wireless open network. The network 610 may also coordinate communication over other networks, such as Public Switched Telephone Network (PSTN) or cellular networks. Furthermore, the network 610 may include multiple short-range wireless networks, such as Bluetooth, or similar ones. The network 610 may provide communication between the nodes described herein. By way of example, and not limitation, the network 610 may include wireless media. The wireless media may include, among others, acoustic media, RF media, infrared media, and other wireless media.

A textual scheme, a graphical scheme, an audio scheme, an animation scheme, a coloring scheme, a highlighting scheme, and/or a shading scheme may be employed to provide focused attention in documents and communications and associated functionality.

Many other configurations of computing devices, applications, data sources, and data distribution systems may be employed for providing focused attention in documents and communications. Furthermore, the networked environments discussed in FIG. 6 are for illustration purposes only. Embodiments are not limited to the example applications, modules, or processes.

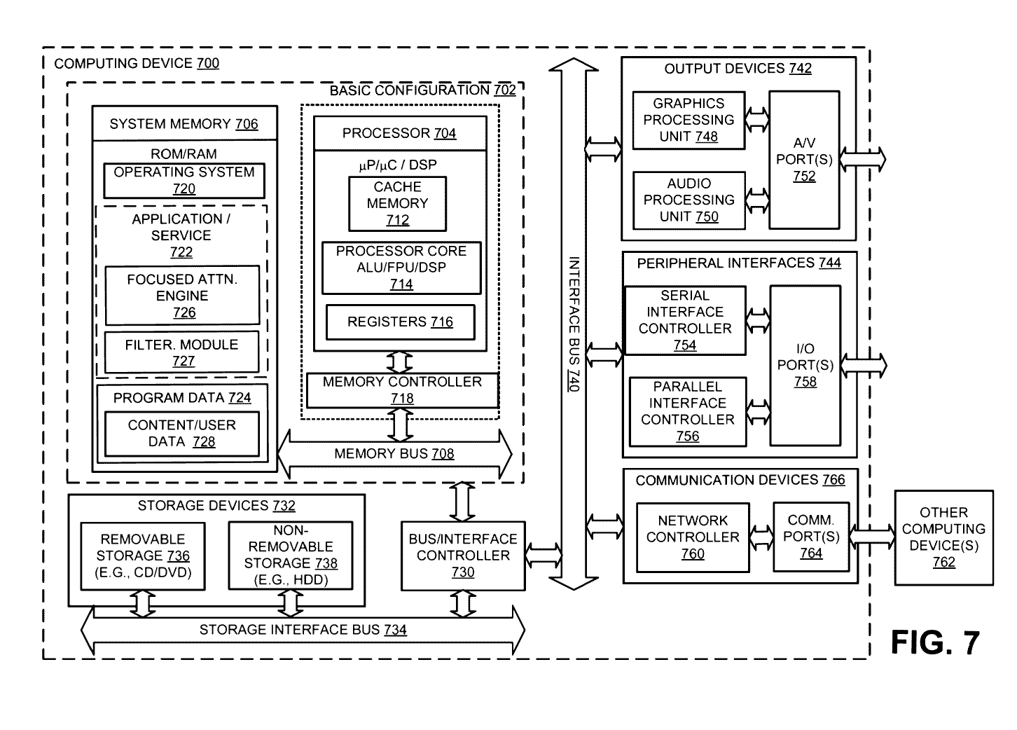

FIG. 7 is a block diagram of an example computing device, which may be used for providing focused attention in documents and communications, according to embodiments.

For example, a computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The example basic configuration 702 may be illustrated in FIG. 5 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The one or more processor cores 714 may (each) include an arithmetic logic unit (ALU), a floating point unit (FPU), a digital signal processing core (DSP Core), or any combination thereof. An example memory controller 718 may also be used with the processor 704, or in some implementations, the example memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, an application/service 722, and a program data 624. The application/service 722 may include a focused attention engine 726, which may provide focused attention in documents and communications, and a filtering module 727, which may enable filtering of received communications based on a property of the communication. Program data 724 may include, among others, user and/or content/user data 728.

The computing device 700 may have additional features or functionality, and additional interfaces to facilitate communications between the example basic configuration 702 and any desired devices and interfaces. For example, a bus/interface controller 730 may be used to facilitate communications between the example basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the example basic configuration 702 via the bus/interface controller 730. Some of the one or more output devices 742 include a graphics processing unit 748 and an audio processing unit 750, which may be configured to communicate to various external devices such as a display or speakers via one or more A/V ports 752. The one more peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods for providing focused attention in documents and communications. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

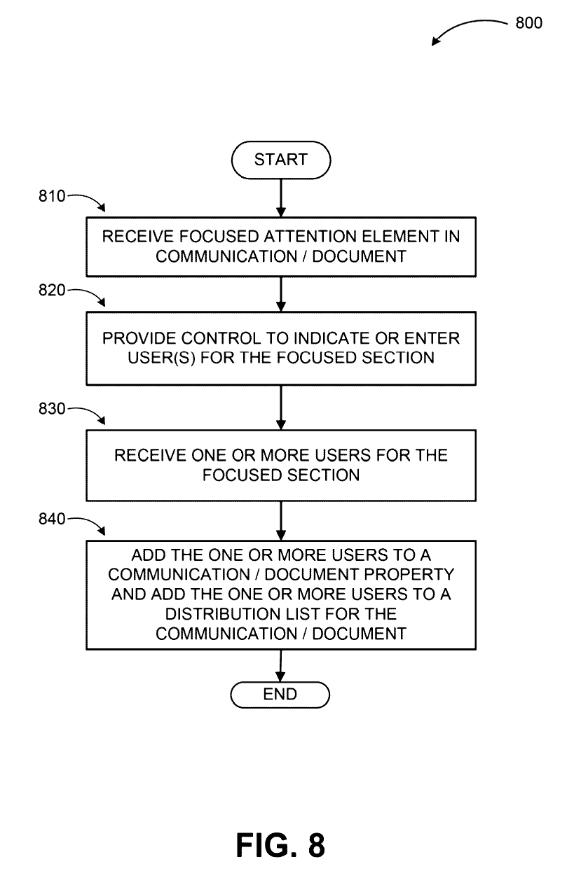

FIG. 8 is a logic flow diagram illustrating a process for providing focused attention in documents and communications, according to embodiments. A process 800 may be implemented by a communication or document collaboration service, a distributed application, a locally installed application, and/or their components, where the components may be executed on one or more servers or other computing devices.

The process 800 may begin with operation 810, where a focused attention element (e.g., an alphanumeric or special character) may be received in a communication or a collaborated document. At operation 820, the focused attention engine may present a control to indicate (e.g., select from a list of suggested users) or to enter a user or multiple users for a focused section of the communication or document.

At operation 830, the focused attention engine may receive one or more users in conjunction with the focused attention element and add the received user(s) to a communication or document property at operation 840. In some embodiments, the user(s) may also be added to a distribution list (e.g., a TO line for an email) for the communication or collaborated document.

The operations included in process 800 are for illustration purposes. Providing focused attention in documents and communications may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device to provide focused attention in exchange of communications is described. The computing device may include a memory and one or more processors coupled to the memory, the one or more processors executing a communication application in conjunction with instructions stored in the memory. The communication application may include a conversation management module configured to facilitate the exchange of communications among multiple participants and a focused attention module. The focused attention module may be configured to receive a focused attention element within a body of a communication; provide a control to be displayed for enabling input or selection of one or more participants in conjunction with the focused attention element; receive the input or the selection of the one or more participants; add identifiers for the one or more participants to a property of the communication; and add contact information for the one or more participants to a distribution list of the communication if the one or more participants are not on the distribution list. The communication application may also include a filtering module configured to enable filtering of received communications based on the property of the communication.

According to other examples, the focused attention module may be configured to detect the focused attention element as one or more predefined characters input in a new line or following a space. The one or more predefined characters may include alphanumeric characters, special characters, and graphical characters. The focused attention module may be further configured to enable typing of a name of a participant following the focused attention element and/or provide one of an auto-complete functionality and a people picker menu to select the participant. The focused attention module may be further configured to retrieve an identifier and a contact information for the participant based on the typed or selected name and present a list of participants on the people picker menu based on one or more of a sender's contacts, people the sender exchanges communications with, people associated with a particular project, and people within a same organization as the sender.

According to further examples, the list of participants on the people picker menu may be selected and/or ordered based on one or more of: one or more letters of the name typed by the sender, a context of the communication, or an inference made from a history of interactions of the sender with people, and a subject of the communication. The focused attention module may also be configured to enable inputting of content directed to the participant following the typed name, the content including one or more of text, a graphic, an image, video content, audio content, a link, and an attachment. The focused attention module may be further configured to, upon completion of the name following the focused attention element, emphasize one or both of the focused attention element and the name through one or more of a highlighting scheme, a coloring scheme, a shading scheme, a textual scheme, and a graphic scheme. The focused attention module may be further configured to enable typing or selection from a people picker menu of a plurality of names of a plurality of participants following the focused attention element.

According to other examples, a method executed at one or more computing devices to provide focused attention in a communication or document is described. The method may include facilitating one or more of an exchange of communications and a collaboration on a document among multiple users; receiving a focused attention element within as body of a communication or the document; providing a control to be displayed for enabling input or selection of one or more users in conjunction with the focused attention element; receiving the input or the selection of the one or more users; adding the one or more users to a property of the communication or the document; and adding the one or more users to a distribution list of the communication or the document.

According to some examples, the method may further include indexing the communication or the document based on the property to enable filtering of the communication or the document by the one or more users; enabling filtering of one or more communications or documents based on a name of a user associated with the focused attention element; enabling filtering of one or more communications or documents based on a plurality of names of a plurality of users associated with the focused attention element; and enabling grouping of the filtered one or more communications or documents based on selected names. The communication may be an email, a scheduling item, a text message, a shared note, a shared task, and/or an online conference, and the document may be a word processing document, a presentation document, a spreadsheet, and/or a graphics document.

According to further examples, a computer-readable memory device with instructions stored thereon to provide focused attention in exchange of communications is described. The instructions may include facilitating the exchange of communications among multiple participants; receiving a focused attention element within a body of a communication, where the focused attention element includes one or more of alphanumeric characters, special characters, and graphical characters; providing a control to be displayed for enabling input or selection of one or more participants in conjunction with the focused attention element; receiving the input or the selection of the one or more participants; adding identifiers for the one or more participants to a property of the communication; adding contact information for the one or more participants to a distribution list of the communication if the one or more participants are not on the distribution list; and enabling filtering of received communications based on the property of the communication.

According to yet other examples, the instructions may also include providing a focused attention portion comprising the focused attention element, one or more names associated with the focused attention element, and content associated with the focused attention element to be displayed in one of a preview of the communication and a top body portion of the communication upon receipt of the communication by a recipient. The instructions may further include enabling one or more received communications to be displayed with communications containing the focused attention element being emphasized through one or more of a height, a background color, a font style, a weight, a font color, an icon, and a label of the displayed communications. The instructions may also include upon selection of a name associated with the focused attention element on a displayed communication providing one or more of summary information and interactivity functionality associated with the name to be displayed.

According to other examples, a means for providing focused attention in a communication or document is described. The means may include a means for facilitating one or more of an exchange of communications and a collaboration on a document among multiple users; a means for receiving a focused attention element within a body of a communication or the document; a means for providing a control to be displayed for enabling input or selection of one or more users in conjunction with the focused attention element; a means for receiving the input or the selection of the one or more users; a means for adding the one or more users to a property of the communication or the document; and a means for adding the one or more users to a distribution list of the communication or the document.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide focused attention in exchange of communications, the computing device comprising:
a memory;
one or more processors coupled to the memory, the one or more processors executing a communication application in conjunction with instructions stored in the memory, wherein the communication application includes:
a conversation management module configured to:
facilitate the exchange of communications among multiple participants;
a focused attention module configured to:
receive a focused attention element within a body of a communication;
provide a control to be displayed for enabling input or selection of one or more participants in conjunction with the focused attention element;
receive the input or the selection of the one or more participants;
add identifiers for the one or more participants to a property of the communication; and
add contact information for the one or more participants to a distribution list of the communication if the one or more participants are not on the distribution list; and
a filtering module configured to:
enable filtering of received communications based on the property of the communication.

2. The computing device of claim 1, wherein the focused attention module is configured to detect the focused attention element as one or more predefined characters input in a new line or following a space.

3. The computing device of claim 2, wherein the one or more predefined characters include alphanumeric characters, special characters, and graphical characters.

4. The computing device of claim 1, wherein the focused attention module is further configured to enable typing of a name of a participant following the focused attention element.

5. The computing device of claim 4, wherein the focused attention module is further configured to provide one of an auto-complete functionality and a people picker menu to select the participant.

6. The computing device of claim 5, wherein the focused attention module is further configured to retrieve an identifier and a contact information for the participant based on the typed or selected name.

7. The computing device of claim 5, wherein the focused attention module is further configured to present a list of participants on the people picker menu based on one or more of a sender's contacts, people the sender exchanges communications with, people associated with a particular project, and people within a same organization as the sender.

8. The computing device of claim 7, wherein the list of participants on the people picker menu is selected and/or ordered based on one or more of: one or more letters of the name typed by the sender, a context of the communication, or an inference made from a history of interactions of the sender with people, and a subject of the communication.

9. The computing device of claim 4, wherein the focused attention module is further configured to enable inputting of content directed to the participant following the typed name, the content including one or more of text, a graphic, an image, video content, audio content, a link, and an attachment.

10. The computing device of claim 4, wherein the focused attention module is further configured to, upon completion of the name following the focused attention element, emphasize one or both of the focused attention element and the name through one or more of a highlighting scheme, a coloring scheme, a shading scheme, a textual scheme, and a graphic scheme.

11. The computing device of claim 1, wherein the focused attention module is further configured to enable typing or selection from a people picker menu of a plurality of names of a plurality of participants following the focused attention element.

12. A method executed at one or more computing devices to provide focused attention in a communication or document, the method comprising:
facilitating one or more of an exchange of communications and a collaboration on a document among multiple users;
receiving a focused attention element within a body of a communication or the document;
providing a control to be displayed for enabling input or selection of one or more users in conjunction with the focused attention element;
receiving the input or the selection of the one or more users;
adding the one or more users to a property of the communication or the document; and
adding the one or more users to a distribution list of the communication or the document.

13. The method of claim 12, further comprising:
indexing the communication or the document based on the property to enable filtering of the communication or the document by the one or more users.

14. The method of claim 13, further comprising:
enabling filtering of one or more communications or documents based on a name of a user associated with the focused attention element.

15. The method of claim 13, further comprising:
enabling filtering of one or more communications or documents based on as plurality of names of a plurality of users associated with the focused attention element; and
enabling grouping of the filtered one or more communications or documents based on selected names.

16. The method of claim 12, wherein the communication is one of an email, a scheduling item, a text message, a shared note, a shared task, and an online conference, and the document is one of a word processing document, a presentation document, a spreadsheet, and a graphics document.

17. A computer-readable memory device with instructions stored thereon to provide focused attention in exchange of communications, the instructions comprising:
facilitating the exchange of communications among multiple participants;
receiving a focused attention element within a body of a communication, wherein the focused attention element includes one or more of alphanumeric characters, special characters, and graphical characters;
providing a control to be displayed for enabling input or selection of one or more participants in conjunction with the focused attention element;
receiving the input or the selection of the one or more participants;
adding identifiers for the one or more participants to a property of the communication;
adding contact information for the one or more participants to a distribution list of the communication if the one or more participants are not on the distribution list; and
enabling filtering of received communications based on the property of the communication.

18. The computer-readable memory device of claim 17, wherein the instructions further comprise:
providing a focused attention portion comprising the focused attention element, one or more names associated with the focused attention element, and content associated with the focused attention element to be displayed in one of a preview of the communication and a top body portion of the communication upon receipt of the communication by a recipient.

19. The computer-readable memory device of claim 17, wherein the instructions further comprise:
enabling one or more received communications to be displayed with communications containing the focused attention element being emphasized through one or more of a height, a background color, a font style, a weight, a font color, an icon, and a label of the displayed communications.

20. The computer-readable memory device of claim 17, wherein the instructions further comprise:
upon selection of a name associated with the focused attention element on a displayed communication, providing one or more of summary information and interactivity functionality associated with the name to be displayed.
